(19) United States
(12) Patent Application Publication
(10) Pub. No.: US 2014/0002555 A1
(43) Pub. Date: Jan. 2, 2014

(54) AIR CHAMBER MECHANISM

(71) Applicant: HON HAI PRECISION INDUSTRY CO., LTD., New Taipei (TW)

(72) Inventor: CHIA-SHIEN LIU, New Taipei (TW)

(73) Assignee: HON HAI PRECISION INDUSTRY CO., LTD., New Taipei (TW)

(21) Appl. No.: 13/891,394

(22) Filed: May 10, 2013

(30) Foreign Application Priority Data
Jun. 27, 2012 (TW) 101122903

(51) Int. Cl. B41J 2/19

(52) U.S. Cl. CPC B41J 2/19
USPC 347/92

(57) ABSTRACT

An air chamber mechanism of an inkjet printer includes a chamber holder and an air chamber. The chamber holder defines a receiving slot. The air chamber is detachably received in the receiving slot. The air chamber defines an air intake for receiving airflow from an air pump and an air outtake for blowing the airflow into an ink cartridge.

REFERENCE TO RELATED APPLICATIONS

This application claims all benefits accruing under 35 U.S.C. §119 from Taiwan Patent Application No. 101122903, filed on Jun. 27, 2012 in the Taiwan Intellectual Property Office, the contents of the Taiwan Application are hereby incorporated by reference.

### BACKGROUND

1. Technical Field

The present disclosure generally relates to image formation devices, and particularly relates to an air chamber mechanism of an inkjet printer.

2. Description of Related Art

In an inkjet printer, print heads are used to propel droplets of ink onto a print medium to create an image. The inkjet printer typically includes an air chamber mechanism to guide and blow airflow into ink cartridges to deliver ink to the print heads. However, air chambers of the air chamber mechanism may easily malfunction. When an air chamber does not function correctly, a user has to replace the whole air chamber mechanism.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an air chamber mechanism of an inkjet printer in accordance with an embodiment.

FIG. 2 is similar to FIG. 1, but viewed from a different aspect.

FIG. 3 is an assembled view of the air chamber mechanism of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

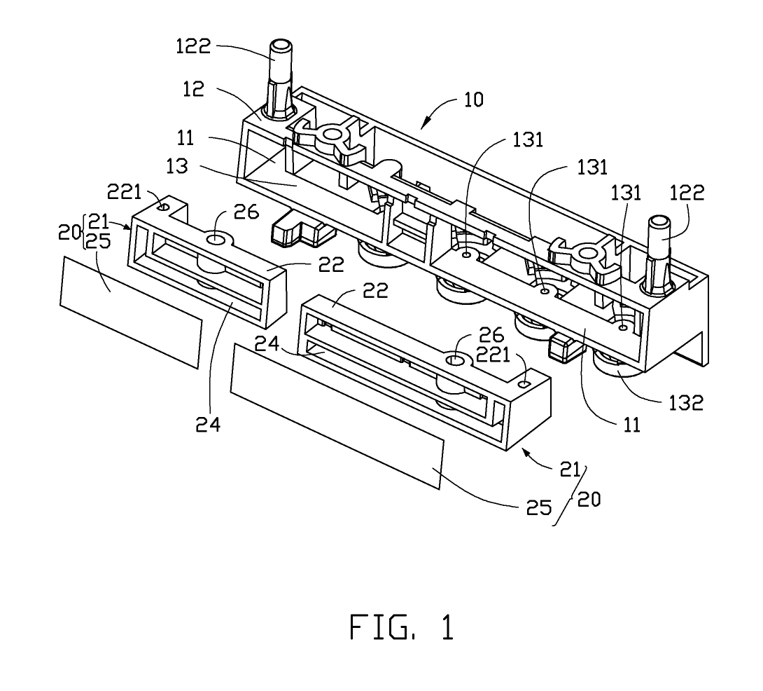

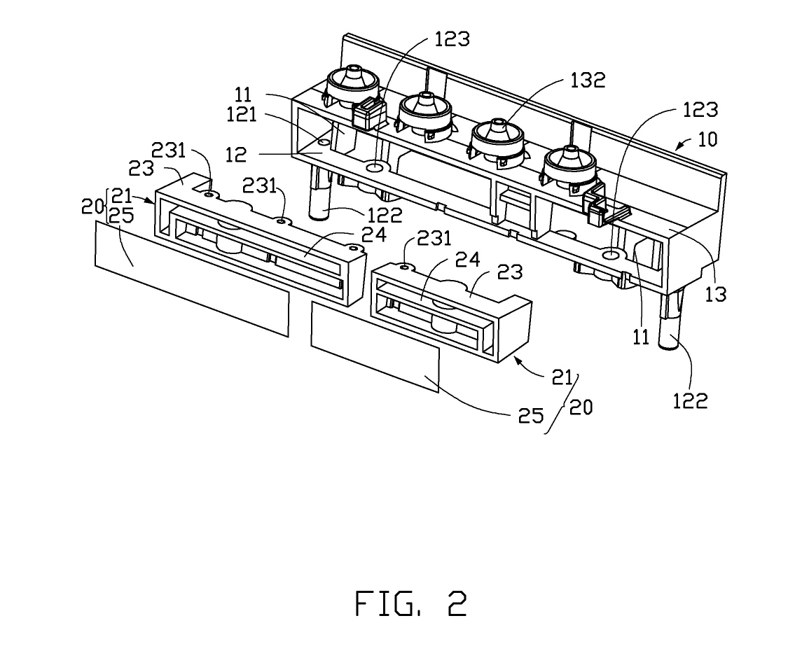

FIGS. 1-3 show an air chamber mechanism of an inkjet printer in accordance with an embodiment. The air chamber mechanism includes a chamber holder 10 and at least one air chamber 20. The chamber holder 10 defines at least one receiving slot 11. Each of the at least one of the receiving slot 11 can receive one of the at least one air chamber 20. In the embodiment shown in FIGS. 1-3, the air chamber mechanism includes two air chambers 20 and the chamber holder 10 defines two receiving slots 11. One of the two air chambers 20 can be connected to color ink cartridges (not shown) and the other of the two air chambers 20 can be connected to a black ink cartridge (not shown).

The chamber holder 10 includes a top wall 12 and a bottom wall 13. The top wall 12 defines at least one air inlet 121. The bottom wall 13 defines at least one air outlet 131. At least one air tube 122 protrudes from an upper side of the top wall 12. Each of the at least one air tube 122 communicates with one of the at least one air inlet 121. Each of the at least one air tube 122 can be connected to an air pump (not shown) and receive airflow from the air pump. At least one air nozzle 132 is attached to a lower side of the bottom wall 13. Each of the at least one air nozzle 132 communicates with one of the at least one air outlet 131 and can be connected to an ink cartridge (not show). In the embodiment, FIGS. 1-3 show that the top wall 12 defines two air inlets 121, and the bottom wall 13 defines four air outlets 131. Two air tubes 122 protrude from the upper side of the top wall 12 and communicate with the two air inlets 121. Four air nozzles 132 are attached to the lower side of the bottom wall 13 and communicate with the four air outlets 131. In some embodiments, the chamber holder 10 is manufactured by integral molding of plastics.

The air chamber 20 includes a chamber body 21 and a cover 25. The chamber body 21 includes a top plate 22 and a bottom plate 23. The top plate 22 defines an air intake 221. The bottom plate 23 defines at least one air outtake 231. Each of the at least one air outtake 231 can communicate with an ink cartridge. The cover 25 covers an opening the chamber body 21. The chamber body 21 together with the cover 25 forms a closed air space 24. In one embodiment, the cover 25 is a heat-stake film and is attached to the chamber body 21 by hot melting. In some embodiments, the chamber body 21 is manufactured by integral molding of plastics.

The top wall 12 of the chamber holder 10 further defines at least one fastening hole 123. The top plate 22 of each air chamber 20 defines a mounting hole 26. In the embodiment shown in FIGS. 1-3, the top wall 12 of the chamber holder 10 defines two fastening holes 123, each of which corresponds to the mounting hole 26 of one of the two air chambers 20.

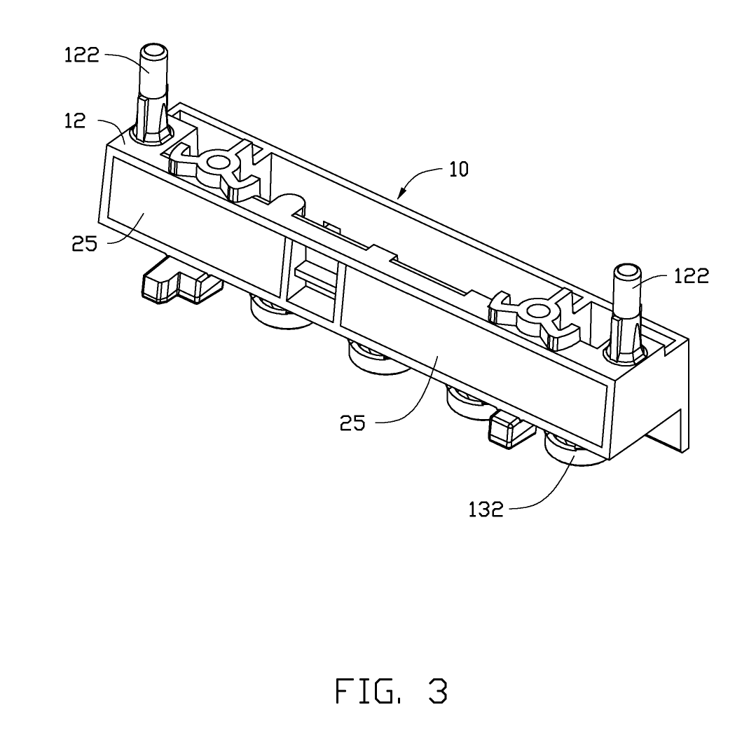

FIG. 3 shows that in assembly, the two air chambers 20 are received in the two receiving slots 11 of the chamber holder 10. The air intake 221 of each of the two air chambers 20 is aligned with and communicates with one of the two air inlets 121 of the chamber holder 10. The air outtake 231 of each of the two air chambers 20 is aligned with and communicates with one of the four air outlets 131 of the chamber holder 10. The mounting hole 26 of each of the two air chambers 20 is aligned with one of the two fastening holes 123 of the chamber holder 10. A bolt (not shown) is screwed into the mounting hole 26 of each of the two air chambers 20 and the corresponding fastening hole 123 of the chamber holder 10. Thus, the two air chambers 20 are fixed in the two receiving slots 11 of the chamber holder 10. In another embodiment, each of the two air chambers 20 is fixed in the corresponding receiving slot 11 of the chamber holder 10 by interference fit.

While the printer equipped with the assembled air chamber mechanism is performing a print task, the air tube 122 receives airflow from an air pump (not shown) and introduces the airflow into the air chamber 20 through the air intake 221. The airflow is then guided by the air chamber 20 to blow out from the air outtake 231 and into the air nozzle 132. The airflow finally blows into an ink cartridge connected to the air nozzle 132 and delivers ink to print heads. The print heads then can propel droplets of ink onto a print medium to create an image.

When one of the two air chamber 20 is not working normally, a printer user or administrator may just remove the bad air chamber 20 from the chamber holder 10 and place a new one into the receiving slot 11 of the chamber holder, instead of replacing the whole air chamber mechanism.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An air chamber mechanism of an inkjet printer, comprising:
a chamber holder defining a receiving slot;
an air chamber detachably received in the receiving slot, wherein the air chamber defines an air intake configured to receive airflow from an air pump and an air outtake configured to blow the airflow into an ink cartridge.

2. The air chamber mechanism of claim 1, wherein the air chamber comprises a chamber body and a cover attached to an opening of the chamber body, the chamber body and the cover form a closed air space.

3. The air chamber mechanism of claim 2, wherein the cover is a heat-stake film attached to the chamber body by hot melting.

4. The air chamber mechanism of claim 2, wherein the chamber body comprises a top plate defining the air intake and a bottom plate defining the air outtake.

5. The air chamber mechanism of claim 2, wherein the chamber body is integral molded plastics.

6. The air chamber mechanism of claim 4, wherein the chamber holder comprises a top wall defining an air inlet and a bottom wall defining an air outlet, the air intake is aligned with and communicates with the air inlet, and the air outtake is aligned with and communicates with the air outlet.

7. The air chamber mechanism of claim 6, wherein the air chamber mechanism further comprises an air tube protruding from an upper side of the top wall of the chamber holder, the air tube communicates with the air inlet of the chamber holder, the air tube is configured to be connected to the air pump and to receive the airflow from the air pump.

8. The air chamber mechanism of claim 6, wherein the air chamber mechanism further comprises an air nozzle attached to an lower side of the bottom wall of the chamber holder, the air nozzle communicates with the air outlet of the chamber holder, the air nozzle is configured to be connected to the ink cartridge and to introduce the airflow into the ink cartridge.

9. The air chamber mechanism of claim 6, wherein the chamber holder defines a fastening hole, the air chamber defines a mounting hole, the air chamber mechanism further comprises a bolt screwed into the fastening hole and the mounting hole thereby fixing the air chamber in the receiving slot of the chamber holder.

10. The air chamber mechanism of claim 9, wherein the fastening hole is on the top wall of the chamber holder, and the mounting hole is on the top plate of the air chamber.

11. The air chamber mechanism of claim 1, wherein the air chamber is fixed in the receiving slot of the chamber holder by interference fitting.

12. The air chamber mechanism of claim 1, wherein the chamber holder is manufactured by integral molding of plastics.

13. An air chamber mechanism of an inkjet printer, comprising:
a chamber holder defines a receiving slot, an air inlet configured to receive airflows from an air pump, and an air outlet configured to blow the airflow into an ink cartridge;
an air chamber detachably received in the receiving slot, wherein the air chamber defines an air intake and an air outtake, the air intake is aligned with and communicates with the air inlet, and the air outtake is aligned with and communicates with the air outlet.

14. The air chamber mechanism of claim 13, wherein the air chamber comprises a chamber body and a cover attached to an opening of the chamber body, the chamber body and the cover form a closed air space.

15. The air chamber mechanism of claim 14, wherein the cover is a heat-stake film attached to the chamber body by hot melting.

16. The air chamber mechanism of claim 14, wherein the chamber body comprises a top plate defining the air intake and a bottom plate defining the air outtake.

17. The air chamber mechanism of claim 16, wherein the chamber holder comprises a top wall defining the air inlet and a bottom wall defining the air outlet, the air chamber mechanism further comprises an air tube protruding from an upper side of the top wall of the chamber holder, the air tube communicates with the air inlet of the chamber holder, the air tube is configured to be connected to the air pump and to receive the airflow from the air pump.

18. The air chamber mechanism of claim 17, wherein the air chamber mechanism further comprises an air nozzle attached to an lower side of the bottom wall of the chamber holder, the air nozzle communicates with the air outlet of the chamber holder, the air nozzle is configured to be connected to the ink cartridge and to introduce the airflow into the ink cartridge.

19. The air chamber mechanism of claim 17, wherein the top wall of the chamber holder defines a fastening hole, the top plate of the air chamber defines a mounting hole, the air chamber mechanism further comprises a bolt screwed into the fastening hole and the mounting hole thereby fixing the air chamber in the receiving slot of the chamber holder.

20. The air chamber mechanism of claim 13, wherein the air chamber is fixed in the receiving slot of the chamber holder by interference fitting.
